(19) United States
(12) Patent Application Publication
(10) Pub. No.: US 2020/0008422 A1
(43) Pub. Date: Jan. 9, 2020

(54) Biocide Composition

(71) Applicant: Seipasa S.A., Tardienta (Huesca) (ES)

(72) Inventors: Francisco Espinosa Escrig, Tardienta (Huesca) (ES); Noelia Vera Calvo, Tardienta (Huesca) (ES); Pedro Peleato Estaun, Tardienta (Huesca) (ES)

(21) Appl. No.: 16/490,353

(22) PCT Filed: Feb. 19, 2018
(86) PCT No.: PCT/ES2018/070115

§ 371 Date: Aug. 30, 2019

(30) Foreign Application Priority Data
Mar. 1, 2017 (ES) P201730280

(51) Int. Cl. A01N 31/02; A01N 65/42; A01N 25/04

(52) U.S. Cl. CPC A01N 31/02; A01N 25/04; A01N 65/42

(57) ABSTRACT

The present invention relates to a biocidal composition. A biocidal composition including diallyl sulfides as a biocidal agent is described. The composition is characterized by surface active agents. The biocidal composition includes at least one allyl sulfide, a polar diluent, surface active agents, a C4-C9 alkanol, at least one non-ionic surfactant with an HLB value between 9.5 and 17, and at least one anionic surfactant. The described biocidal compositions are effective in treatment against mites, lepidopterous larvae, and thrips.

### FIELD OF THE INVENTION

mon The present invention describes a biocidal composition comprising diallyl sulfides as a biocidal agent. The composition is characterized by surface active agents.

### BACKGROUND OF THE INVENTION

In recent years, there has been an inclination to put environmentally friendly biocidal agents on the market. Plant extracts and their active ingredients have exhibited biocidal activity for different types of pests and pathogens, particularly in agricultural crops.

In particular, as described in US 2009/0317500, diallyl sulfides present in garlic oil and garlic extracts have exhibited repellant properties.

Certain natural products are also known to be toxic for some mammals and the environment. Pyrethrins isolated from Tanacetum cinerariifolium have been used as an insecticide because they attack the nervous system of insects, although different studies show pyrethrin intoxication in mammals and pyrethrin toxicity in bees.

Extracts from the Liliaceae family, comprising diallyl sulfides and alkylcysteine sulfoxides, are to known to exhibit biocidal activity but are unstable.

The state of the art describes a variety of surface active agents: anionic compounds, cationic compounds, non-ionic compounds, ampholytes, or mixtures thereof.

Non-ionic surfactants include, among others: alcohols, phenols, polyoxyalkylene ethers having mixtures of oxyalkylene, carboxylate, and sulfonates groups of polyoxyalkylene glycols, amine oxides, sulfoxides, polysorbates, alkyl polyglucosides, synthetic resins, phosphoric acid esters, phosphine oxides, lignin derivatives, silicon compounds, ethoxylated seed oils, products of an undetermined composition, etc.

The hydrophilic-lipophilic balance or HLB of a surfactant is a measure of the degree to which it is hydrophilic or lipophilic, determined by means of calculating values for the different regions of the molecule. HLB can be calculated by means of the methods described by Griffin or Davies. HLB values range from 1.5 for anti-foaming agents to 18 for solubilizers.

Document CN103535389 describes an insecticidal composition against red spider mites comprising garlic extracts and pyrethrins. Accordingly, this formulation can lead to intoxication in mammals.

The document closest to the invention, i.e., document CN1615704, describes a composition against red spider mites comprising juice obtained by means of crushing and fermenting garlic, chili, and castor oil. This document does not describe the stability of the components nor does it quantify the effectiveness of the formulation.

### Objective of the invention

The problem solved by the invention relates to finding a biocidal composition comprising diallyl sulfides which is stable over time. The solution found by the inventors is a composition comprising a polar diluent, a C4-C9 alkanol, characterized by surface active agents.

The surface active agents comprise at least one non-ionic surfactant and one anionic surfactant, wherein the non-ionic surfactant has an HLB value between 9 and 17.

The non-ionic surfactants are selected from:

ethoxylated sorbitan esters,

ethoxylated oils or fatty acids, and

ethoxylated fatty acid alcohols.

The anionic surfactants comprise arylsulfosuccionate salts, arylbenzene sulfonate salts, or ethoxylated aryl alkyl phosphate esters.

The concentrations of allyl sulfide of the described formulations remained unchanged for 14 days stored at 54° C. It can thus be extrapolated that the formulations will be stable for at least two years at room temperature.

Another problem solved by the invention relates to finding a pyrethrin-free biocidal composition against red spider mites that is not toxic for mammals or the environment.

The formulations described in the invention showed an efficacy statistically similar to those obtained by fenpyroximate or abamectin, which are toxic reference biocidal agents.

The described formulations were also effective against different lepidopterous species affecting horticultural crops, such as, Spodoptera exigua and Mamestra brassicae, Helicoverpa armigera, Tuta absoluta, Pieris rapae, or Phyllocnistis citrella); tetranychid mites, such as Tetranychus urticae, Panonychus citri, Eutetranychus orientalis; and thrips, such as, Frankliniella occidentalis, Thrips tabaci, or Pezothrips kellyanus.

### BRIEF DESCRIPTION OF THE DRAWINGS

FIGS. 1 and 2 show the efficacy, in terms of population of mites (FIG. 1) and percent efficacy (FIG. 2), of the emulsifiable compositions (EC) and the microemulsion compositions (ME) per applications to the crop in the treatment of apple tree red spider mites in comparison with fenpyroximate.

FIGS. 3 and 4 show the efficacy, in terms of population of mites (FIG. 3) and percent efficacy (FIG. 4), of the emulsifiable compositions (ec or EC) and the microemulsion compositions (me or ME) per applications to the crop in the treatment of peach red spider mites in comparison with fenpyroximate.

FIGS. 5 and 6 show the efficacy, in terms of population of mites (FIG. 5) and percent efficacy (FIG. 6), of the emulsifiable compositions (EC) and the microemulsion compositions (ME) per applications to crop on citrus fruit red spider mites in comparison with abamectin.

FIGS. 7 and 8 show the efficacy of the emulsifiable compositions (EC) and the microemulsion compositions (ME) per applications to crop in the treatment of lettuce worms (Spodoptera exigua) in comparison with azadirachtin.

FIG. 9 shows the efficacy of the emulsifiable compositions (EC) and the microemulsion compositions (ME) per applications to crop on pepper worms in comparison with Bacillus thuringiensis.

FIG. 10 shows efficacy of the emulsifiable compositions (EC) and the microemulsion compositions (ME) per applications to crop on Frankliniella occidentalis in peppers in comparison with azadirachtin.

In the drawings, the reference MEGE corresponds to microemulsion formulations of garlic extract and the reference ECGE corresponds to emulsifiable formulations of garlic extract.

### DETAILED DESCRIPTION OF THE INVENTION

The compositions comprise:
at least one diallyl sulfide,
a polar diluent,
surface active agents,
a C4-C9 alkanol, and
wherein the surface active agents comprise at least one non-ionic surfactant with an HLB value between 9.5 and 17 and at least one anionic surfactant.

The diallyl sulfides comprise diallyl sulfide, diallyl disulfide, diallyl trisulfide, diallyl tetrasulfide defined by the formula:

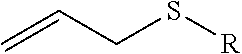

where R is

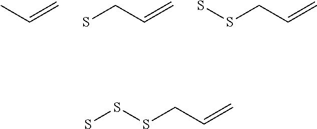

Preferably, the biocidal compositions comprise Allium sativum extracts obtainable by means of methods known to one skilled in the art, as described in detail in Example 7, and said compositions being quantified in diallyl sulfides.

The polar diluents comprise dialkyl succinates, dialkyl glutarates, dialkyl adipate, water, glycols. Preferably, the polar diluents are mixtures of methyl succinate, methyl glutarate, dimethyl adipate, water, or propylene glycol, which are biodegradable diluents.

The non-ionic surface active agents are selected from:

polyoxyethylene sorbitan esters,

ethoxylated oils or fatty acids, and

ethoxylated fatty acid alcohols.

Preferably, the polyoxyethylene sorbitan esters are polyoxyethylene (20) sorbitan monolaurate and polyoxyethylene (20) sorbitan monooleate, wherein the HLB value for polyoxyethylene (20) sorbitan monolaurate is 16.7 and the HLB value for polyoxyethylene (20) sorbitan monooleate is 15.

Preferably, the ethoxylated oils are castor oil with 20 moles of ethylene oxide or castor oil with 36 moles of ethylene oxide, both with CAS number 61791-12-6; wherein the HLB value for ethoxylated castor oil with 20 moles of ethylene oxide is 9.9, whereas the HLB value for castor oil with 36 moles of ethylene oxide is 12.6.

Preferably, the ethoxylated fatty acid is polyethylene glycol laurate (9) with an HLB value of 13.

Preferably, the ethoxylated fatty acid alcohol is ethoxylated isotridecyl alcohol with 8 moles of ethylene oxide with an HLB value of 12.8.

The anionic surfactants are selected from arylsulfosuccionate salts, arylbenzene sulfonate salts, or ethoxylated aryl alkyl phosphate esters.

Preferably, the anionic surfactants are sodium dioctyl sulfosuccinate, calcium dodecylbenzene sulfonate, or aryl alkyl phosphate ester 10 OE.

The C4-C9 alkanol is a primary, secondary, or tertiary aliphatic alcohol with 4-9 carbon atoms. Preferably, the C4-C9 alkanol is 2-ethyl-1-hexanol.

The compositions described in the invention are formulated as an emulsifiable concentrate or microemulsions.

Preferably, the emulsifiable concentrated compositions use a mixture of dimethyl succinate, dimethyl glutarate, and dimethyl adipate as a diluent, whereas the compositions in the form of microemulsions use water and propylene glycol as a diluent.

The described compositions are effective for treatment against tetranychid mites (Tetranychus urticae, Panonychus citri, Eutetranychus orientalis), lepidopterous larvae (Spodoptera exigua, Mamestra brassicae, Helicoverpa armigera, Tuta absoluta, Pieris rapae, Phyllocnistis citrella), and thrips (Frankliniella occidentalis, Thrips tabaci, Pezothrips kellyanus).

### EXAMPLE 1

### Biocidal Microemulsion Compositions

Biocidal microemulsion compositions are described below. All concentrations are expressed in weight/weight. The table describes the HLB (hydrophilic-lipophilic balance) value for non-ionic surfactants.

TABLE 1

| Surfactants | | HLB | % | % | % | % | % | % | % | % | % |
|---|---|---|---|---|---|---|---|---|---|---|---|
| Non-ionic | Castor oil 20 OE | 9.9 | 6 | 8 | 10 | 0 | 0 | 0 | 0 | 0 | 5 |
| | Castor oil 36 OE | 12.6 | 0 | 0 | 0 | 15 | 18 | 20 | 0 | 0 | 0 |
| | Lauric acid 9 OE | 13.3 | 0 | 0 | 0 | 0 | 0 | 0 | 22 | 23 | 0 |
| | Sorbitan | 15 | 7 | 8 | 9 | 0 | 0 | 0 | 0 | 0 | 24 |
| | monooleate 20 | | | | | | | | | | |
| | OE | | | | | | | | | | |
| | Sorbitan | 16.7 | 0 | 0 | 0 | 5 | 6 | 7 | 0 | 0 | 0 |
| | monolaurate 20 | | | | | | | | | | |
| | OE | | | | | | | | | | |
| | Isotridecyl | 12.8 | 0 | 0 | 0 | 0 | 0 | 0 | 11 | 13 | 0 |
| | alcohol 8 OE | | | | | | | | | | |
| Anionic | Sodium salt of | | 10 | 12 | 14 | 0 | 0 | 0 | 0 | 0 | 15 |
| | dioctyl | | | | | | | | | | |
| | sulfosucci-nate | | | | | | | | | | |
| | Calcium | | 0 | 0 | 0 | 2 | 4 | 6 | 0 | 0 | 0 |
| | dodecyl-benzene | | | | | | | | | | |
| | sulfonate | | | | | | | | | | |
| | Aryl alkyl | | 0 | 0 | 0 | 0 | 0 | 0 | 2 | 4 | 0 |
| | phosphate ester | | | | | | | | | | |
| | 10 OE | | | | | | | | | | |
| | Garlic extract | | 1 | 3 | 5 | 1 | 3 | 5 | 1 | 3 | 6 |
| | 2-ethyl-1-hexanol | | 1 | 2 | 3 | 1 | 2 | 3 | 1 | 2 | 3 |
| | Propylene glycol | | 5 | 6 | 8 | 5 | 8 | 10 | 5 | 10 | 12 |
| | Deionized water | | 64 | 53 | 41 | 64 | 50 | 38 | 50 | 35 | 23 |
| | Dimethyl adipate | | 5.3 | 7.1 | 8.9 | 1.5 | 1.9 | 2.3 | 0.1 | 0.1 | 0.1 |
| | Dimethyl | | 0.6 | 0.8 | 1 | 4.1 | 5.3 | 6.5 | 5.3 | 6.6 | 7.9 |
| | glutarate | | | | | | | | | | |
| | Dimethyl | | 0.1 | 0.1 | 0.1 | 1.4 | 1.8 | 2.2 | 2.6 | 3.3 | 4 |
| | succinate | | | | | | | | | | |
| | TOTAL | | 100 | 100 | 100 | 100 | 100 | 100 | 100 | 100 | 100 |

### EXAMPLE 2

### Emulsifiable Concentrated Composition

Emulsifiable biocidal compositions are described below. All concentrations are expressed in weight/weight. The described compositions are applied after diluting in water. The table describes the HLB (hydrophilic-lipophilic balance) value for non-ionic surfactants.

TABLE 2

| Surfactants | | HLB | % | % | % | % | % | % | % | % | % |
|---|---|---|---|---|---|---|---|---|---|---|---|
| Non-ionic | Castor oil 20 OE | 9.9 | 12 | 14 | 16 | 0 | 0 | 0 | 0 | 0 | 0 |
| | Castor oil 36 OE | 12.6 | 0 | 0 | 0 | 7 | 9 | 11 | 0 | 0 | 0 |
| | Lauric acid 9 OE | 13.3 | 0 | 0 | 0 | 0 | 0 | 0 | 6 | 8 | 10 |
| | 20 OE | 15 | 10 | 12 | 14 | 0 | 0 | 0 | 0 | 0 | 0 |
| | monooleate | | | | | | | | | | |
| | Sorbitan | 16.7 | 0 | 0 | 0 | 7 | 9 | 11 | 0 | 0 | 0 |
| | monolaurate 20 | | | | | | | | | | |
| | OE | | | | | | | | | | |
| | Isotridecyl alcohol | 12.8 | 0 | 0 | 0 | 0 | 0 | 0 | 12 | 14 | 16 |
| | 8 OE | | | | | | | | | | |
| Anionic | Sodium salt of | | 7 | 9 | 11 | 0 | 0 | 0 | 0 | 0 | 0 |
| | dioctyl sulfosucci- | | | | | | | | | | |
| | nate | | | | | | | | | | |
| | Calcium dodecyl- | | 0 | 0 | 0 | 4 | 6.5 | 8 | 0 | 0 | 0 |
| | benzene | | | | | | | | | | |
| | sulfonate | | | | | | | | | | |
| | Aryl alkyl | | 0 | 0 | 0 | 0 | 0 | 0 | 4 | 8 | 11 |
| | phosphate ester | | | | | | | | | | |
| | 10 OE | | | | | | | | | | |
| | Garlic extract. | | 7 | 9 | 12 | 7 | 9 | 12 | 7 | 9 | 12 |
| | 2-ethyl-1- | | 1 | 2 | 3 | 1 | 3 | 3 | 1 | 2 | 3 |
| | hexanol | | | | | | | | | | |
| | Propylene glycol | | 0 | 0 | 0 | 0 | 0 | 0 | 0 | 0 | 0 |
| | Deionized water | | 0 | 0 | 0 | 0 | 0 | 0 | 0 | 0 | 0 |
| | Dimethyl adipate | | 56.1 | 48.1 | 39.2 | 15.5 | 13.3 | 11.6 | 0.7 | 0.6 | 0.5 |
| | Dimethyl | | 6.3 | 5.4 | 4.4 | 43.7 | 37.5 | 32.5 | 46.2 | 38.9 | 31.7 |
| | glutarate | | | | | | | | | | |
| | Dimethyl | | 0.6 | 0.5 | 0.4 | 14.8 | 12.7 | 11 | 23.1 | 19.5 | 15.8 |
| | succinate | | | | | | | | | | |
| | TOTAL | | 100 | 100 | 100 | 100 | 100 | 100 | 100 | 100 | 100 |

The formulations were diluted in water to create an emulsion and for subsequent application.

### EXAMPLE 3

### Stability Studies

An accelerated stability study was performed and the allyl sulfide content in the emulsifiable formulation was determined according to Table 3:

TABLE 3

| | % |
|---|---|
| Lauric acid 9 OE | 10 |
| Isotridecyl alcohol 8 OE | 16 |
| Aryl alkyl phosphate ester 10 OE | 11 |
| Garlic extract | 12 |
| 2-ethyl-1-hexanol | 3 |
| Dimethyl adipate | 0.5 |
| Dimethyl glutarate | 31.7 |
| Dimethyl succinate | 15.8 |
| TOTAL | 100 |

wherein the concentration of allyl sulfides in the preceding composition is described in detail in Table 4.

TABLE 4

| 12% garlic | % (w/w) | % (w/w) | | % (w/w) |
|---|---|---|---|---|
| extract | Diallyl | Diallyl | % (w/w) | Diallyl |
| (w/w) | sulfide | disulfide | Diallyl trisulfide | tetrasulfide |
| 25° C. | 0.59 | 5.02 | 2.59 | 0.98 |
| T = 0 days | | | | |
| 54° C. | 0.57 | 5.01 | 2.57 | 0.97 |
| T = 14 days | | | | |

An accelerated stability study was performed and the allyl sulfide content in the composition in the form of the microemulsion described in detail in Table 5 was determined.

TABLE 5

| % | % |
|---|---|
| Garlic extract | 1 |
| Castor oil 36 OE | 6 |
| Sorbitan monolaurate 20 OE | 7 |
| Calcium dodecylbenzene sulfonate | 10 |
| 2-ethyl-1-hexanol | 1 |
| Propylene glycol | 5 |
| Deionized water | 64 |
| Dimethyl adipate | 5.3 |
| Dimethyl glutarate | 0.6 |
| Dimethyl succinate | 0.1 |
| TOTAL | 100 |

wherein the concentration of allyl sulfides in the preceding composition is described in detail in Table 6:

TABLE 6

| 1% garlic | % (w/w) | % (w/w) | | % (w/w) |
|---|---|---|---|---|
| extract | Diallyl | Diallyl | % (w/w) | Diallyl |
| (w/w) | sulfide | disulfide | Diallyl trisulfide | tetrasulfide |
| 25° C. | 0.05 | 0.42 | 0.22 | 0.08 |
| T = 0 days | | | | |
| 54° C. | 0.55 | 0.41 | 0.21 | 0.08 |
| T = 14 days | | | | |

### EXAMPLE 4

### Efficacy Study on Apple Tree Red Spider Mites

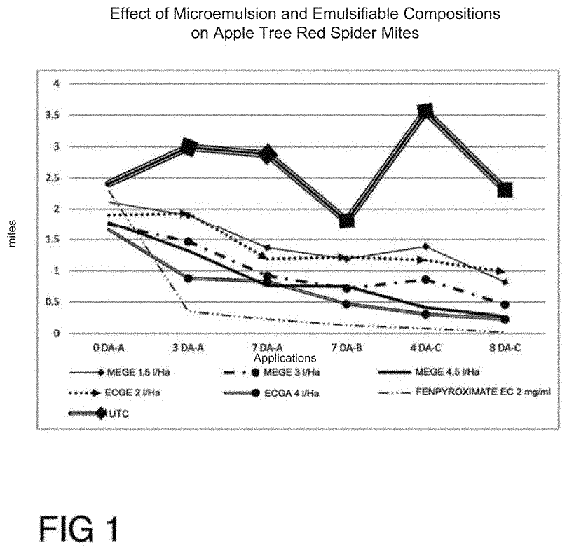

A study was performed to evaluate the efficacy of the emulsifiable compositions and the microemulsion compositions. The number of individual red spider mites per leaf was significantly reduced, particularly at medium and high doses of the microemulsions (3 and 4.5 I/Ha) and at a high dose of the emulsifiable compositions (4 I/Ha). FIG. 1.

The formulations used for the efficacy studies were: Microemulsion compositions according to Table 7

TABLE 7

| % | % |
|---|---|
| Garlic extract | 1 |
| Castor oil 36 OE | 15 |
| Sorbitan monolaurate 20 OE | 5 |
| Calcium dodecylbenzene sulfonate | 2 |
| 2-ethyl-1-hexanol | 1 |
| Propylene glycol | 5 |
| Deionized water | 64 |
| Dimethyl adipate | 1.5 |
| Dimethyl glutarate | 4.1 |
| Dimethyl succinate | 1.4 |
| TOTAL | 100 |

wherein the concentration of allyl sulfides in the composition is described in detail in Table 8.

TABLE 8

| 1% garlic | % (w/w) | % (w/w) | | % (w/w) |
|---|---|---|---|---|
| extract | Allyl | Allyl | % (w/w) | Allyl |
| (w/w) | sulfide | disulfide(w/w) | Allyl trisulfide | tetrasulfide |
| | 0.05 | 0.42 | 0.23 | 0.08 |

The emulsifiable composition used is described in detail in Table 9.

TABLE 9

| % | % |
|---|---|
| Garlic extract | 12 |
| Castor oil 36 OE | 11 |
| Sorbitan monolaurate 20 OE | 11 |
| Calcium dodecylbenzene sulfonate | 8 |
| 2-ethyl-1-hexanol | 3 |
| Dimethyl adipate | 11.6 |
| Dimethyl glutarate | 32.5 |
| Dimethyl succinate | 11 |
| TOTAL | 100 |

wherein the concentration of allyl sulfides is described in detail in Table 10.

TABLE 10

| 12% garlic | % (w/w) | % (w/w) | | % (w/w) |
|---|---|---|---|---|
| extract | Diallyl | Diallyl | % (w/w) | Diallyl |
| (w/w) | sulfide | disulfide(w/w) | Diallyl trisulfide | tetrasulfide |
| | 0.59 | 5.02 | 2.59 | 0.98 |

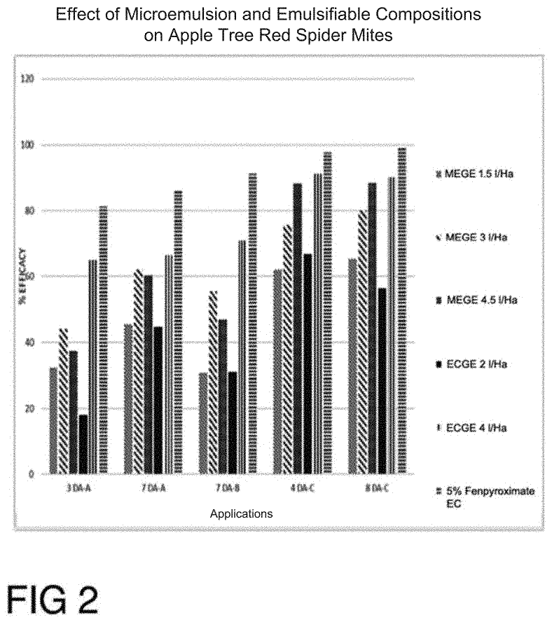

A study was performed to evaluate the efficacy of the emulsifiable compositions and the microemulsion compositions described above (Tables 8-10). Medium and high doses of the microemulsion compositions (3 and 4.5 I/Ha) and a high dose of the emulsifiable formulations (4 I/Ha) reached efficacies of 80-90%, which are statistically similar to those obtained by the reference (fenpyroximate). FIG. 2.

### EXAMPLE 5

### Efficacy Study in Peach Red Spider Mites

An efficacy study in peach red spider mites was performed on the compositions described in detail in Tables 8-10.

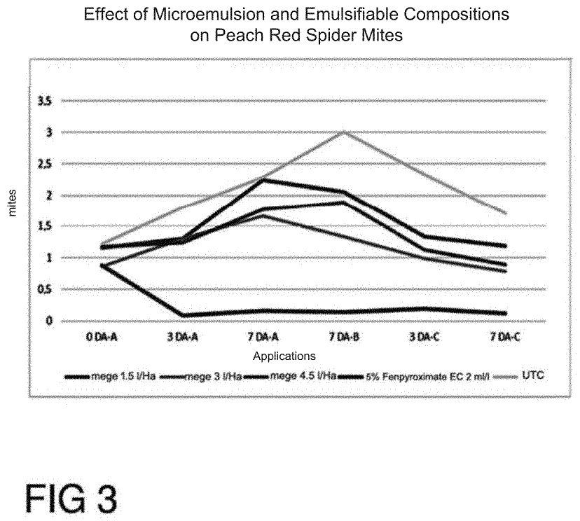

It was observed that the spider mite populations exhibit a less pronounced increase in the treatments of the microemulsion formulation and significant differences are observed with the control populations after the third application of the product. FIG. 3.

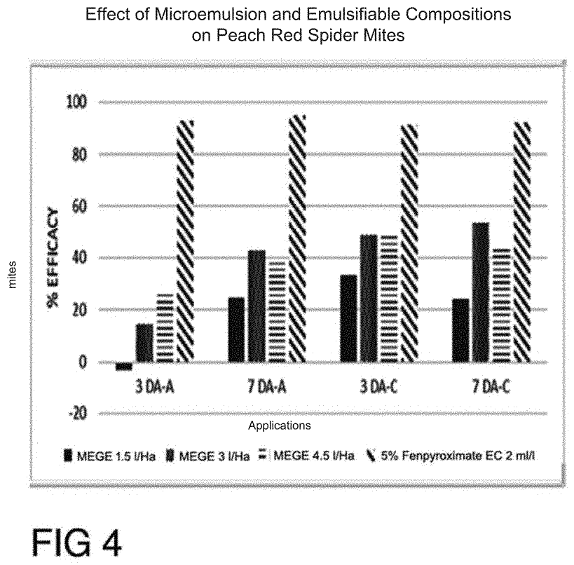

The efficacies obtained using the microemulsion formulation reach mean values for the medium (3 I/Ha) and high (4.5 I/Ha) doses, with a maximum efficacy of 53%. FIG. 4

### EXAMPLE 6

### Efficacy Study on Citrus Fruit Red Spider Mites

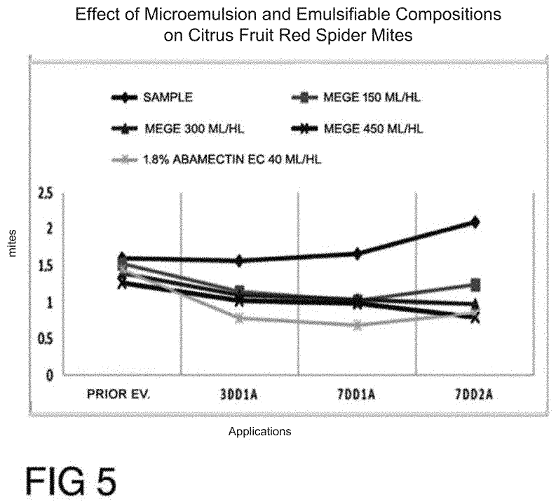

The severity of the formulation described in Tables 7-8 (150, 300, and 450 ml/hl) at 3 doses was studied. The results show a decrease in red spider mite populations. Seven days after the second application (7DD2A), the medium and high doses have populations similar to those of the reference (abamectin). FIG. 5.

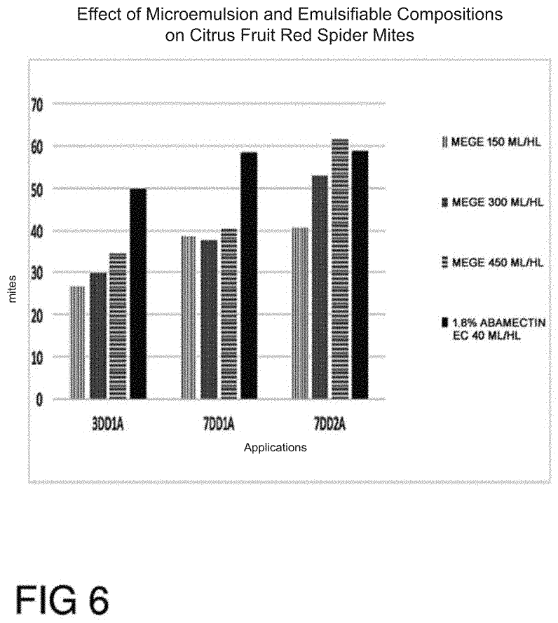

Efficacy after 2 applications was studied, with the medium and high doses of the formulation described in Tables 7-8 showing efficacies of the order of 53-62%, which are similar to those of the reference (abamectin). FIG. 6

### EXAMPLE 7

### Obtaining Garlic Extracts

Garlic extract is obtained from any variety of Allium sativum cultured without pesticide residues.

Dry and chopped cloves of garlic are extracted by means of a stream of water vapor. Water is eliminated from the obtained oil by condensation. The obtained oil has a density of 1.07-1.09 mg/ml and an Oil refractive index of 1.56-1.58.

### EXAMPLE 8

### Efficacy Study in Lettuce Worms (Spodoptera exigua)

An efficacy study was performed in lettuce worms (Spodoptera exigua) for different compositions as described in detail below.

| Treat. | | | | |
|---|---|---|---|---|
| No. | Type | Active ingredient | Concentration | Dose |
| 1 | Control | — | | |
| 2 | Microemulsion | Garlic extract | 3% | 1.5 l/Ha |
| 3 | Microemulsion | Garlic extract | 3% | 3.0 l/Ha |
| 4 | Microemulsion | Garlic extract | 3% | 4.5 l/Ha |
| 5 | Emulsifiable | Garlic extract | 9% | 2.0 l/Ha |
| | concentrate | | | |
| 6 | Emulsifiable | Azadirachtin | 3.2% | 125 ml/100 l |
| | concentrate | | | |

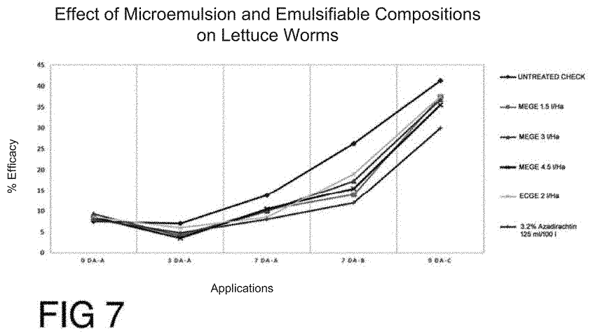

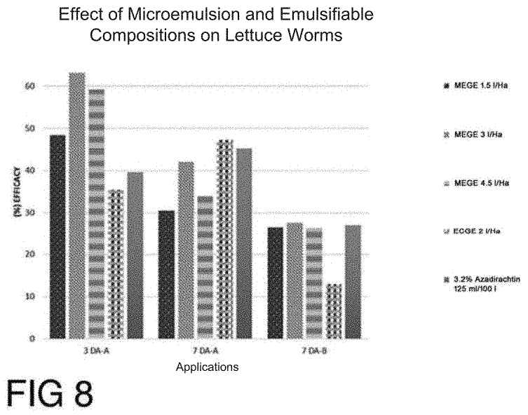

The results obtained for formulations containing garlic extracts, quantified in allyl polysulfides, were equivalent to the results obtained with the reference product (azadirachtin) at 3 and 9 days of application. FIGS. 7 and 8.

### EXAMPLE 9

### Efficacy Study in Peppers (Mamestra brassicae, Autographa gamma, and Other Worms)

An efficacy study was performed in pepper worms (Mamestra brassicae) and other worms for the different compositions as described in detail below:

| Treat. | | | | |
|---|---|---|---|---|
| No. | Type | Active ingredient | Concentration | Dose |
| 1 | Microemulsion | Garlic extract | 3% | 1500 ml/Ha |
| 2 | Microemulsion | Garlic extract | 3% | 3000 ml/Ha |
| 3 | Microemulsion | Garlic extract | 3% | 4500 ml/Ha |
| 4 | Emulsifiable | Garlic extract | 3% | 2000 ml/Ha |
| | concentrate | | | |
| 5 | Emulsifiable | Garlic extract | 9% | 4000 ml/Ha |
| | concentrate | | | |
| 6 | Wettable | Bacillus | 10% | 600 g/Ha |
| | powder | thuringiensis | | |
| | | 15 million | | |
| | | international units | | |
| | | (MIU)/g | | |
| 7 | CONTROL | — | | |

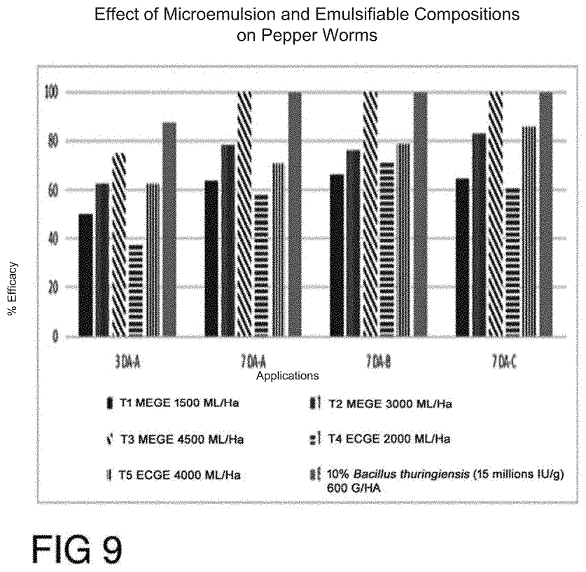

The results obtained for formulations containing garlic extracts, quantified in allyl polysulfides, were equivalent to the results obtained with the reference products Bacillus thuringiensis subspecies Aizawai (15 MIU/g). FIG. 9.

### EXAMPLE 10

### Efficacy Study on Thrips (Frankliniella occidentalis) in Peppers

A study was performed to evaluate the efficacy of emulsifiable compositions versus a composition in the form of a microemulsion, using a 3.2% emulsifiable azadirachtin concentrate as a reference product. The different compositions are described in detail below.

| Treat. | | Active | | |
|---|---|---|---|---|
| No. | Type | ingredient | Concentration | Dose |
| 1 | Control | — | | |
| 2 | Emulsifiable | Garlic extract | 12% | 1.5 l/Ha |
| | concentrate | | | |
| 3 | Emulsifiable | Garlic extract | 12% | 3.0 l/Ha |
| | concentrate | | | |
| 4 | Emulsifiable | Garlic extract | 12% | 4.5 l/Ha |
| | concentrate | | | |
| 5 | Microemulsion | Garlic extract | 5% | 2.0 l/Ha |
| 6 | Emulsifiable | Azadirachtin | 3.2% | 150 ml/100 l |
| | concentrate | | | |

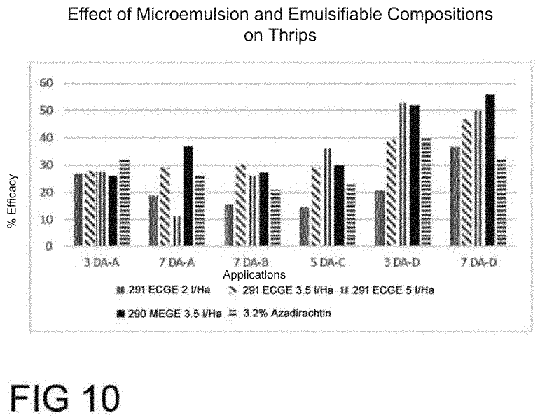

The efficacy results obtained for formulations containing garlic extracts, quantified in allyl polysulfides, showed efficacies similar to or greater than the reference treatment. FIG. 10.

1. A stable biocidal composition comprising:
at least one diallyl sulfide of formula 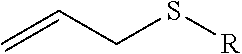
where R is selected from 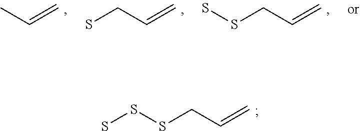
a polar diluent;
surface active agents comprised of at least one non-ionic surfactant with an HLB value between 9.5 and 17 and at least one anionic surfactant; and
a C4-C9 alkanol.

2. The composition according to claim 1, wherein
the non-ionic surfactants are selected from the group consisting of
ethoxylated sorbitan esters,
ethoxylated oils or fatty acids, and
ethoxylated fatty acid alcohols or combinations thereof,
wherein the anionic surfactants are selected from the group consisting of
arylsulfosuccinate salts,
arylbenzene sulfonate salts, and
ethoxylated aryl alkyl phosphate esters or combinations thereof.

3. The composition according to claim 1, wherein the comprises
Allium sativum extract comprising a diallyl sulfide at 1-12% weight/weight,
surface active agents at 18-45% weight/weight,
C4-C9 alkanol at 1-3% weight/weight, and
diluents q.s. to 100%.

4. The composition according to claim 1, wherein the diluent is water, dialkyl succinates, dialkyl glutarates, dialkyl adipate, or propylene glycol.

5. The composition according to claim 1, wherein the C4-C9 alkanol is 2-ethyl-1-hexanol.

6. The composition according to claim 5, wherein the composition is an emulsifiable composition and the diluent is a mixture of dimethyl succinate, dimethyl glutarate, and dimethyl adipate.

7. The composition according to claim 5, wherein the composition is a microemulsion and the diluent is water and propylene glycol.

8. (canceled)

9. A method for decreasing the population of tetranychid mites (Tetranychus urticae, Panonychus citri, Eutetranychus orientalis), lepidopterous larvae (Spodoptera exigua, Mamestra brassicae, Helicoverpa armigera, Tuta absoluta, Pieris rapae, Phyllocnistis citrella) and thrips (Frankliniella occidentalis, Thrips tabaci, Pezothrips kellyanus) that is not toxic to mammals comprising applying the composition of claim 7 to a crop having one or more of tetranychid mites (Tetranychus urticae, Panonychus citri, Eutetranychus orientalis), lepidopterous larvae (Spodoptera exigua, Mamestra brassicae, Helicoverpa armigera, Tuta absoluta, Pieris rapae, Phyllocnistis citrella) and thrips (Frankliniella occidentalis, Thrips tabaci, Pezothrips kellyanus).
